(19) United States
(12) Patent Application Publication
(10) Pub. No.: US 2012/0125244 A1
(43) Pub. Date: May 24, 2012

(54) MAPPING SOIL HARDNESS

(75) Inventor: Norbert BEAUJOT, Emerald Park Saskatchewan (CA)

(73) Assignee: STRAW TRACK MANUFACTURING INC., Emerald Park SK (CA)

(21) Appl. No.: 13/298,518

(22) Filed: Nov. 17, 2011

(30) Foreign Application Priority Data
Nov. 18, 2010 (CA) 2721596

(51) Int. Cl. A01C 5/06; G06F 19/00; G01V 9/00

(52) U.S. Cl. 111/149; 702/5

(57) ABSTRACT

An apparatus for mapping resistance of soil to a ground engaging tool passing through the soil includes a sensor mechanism operative to measure a resistance force exerted on the ground engaging tool by the soil, and an external guidance system operative to determine a location of the ground engaging tool. A microprocessor receives information from the sensor and external guidance system and plots the force against the location of the ground engaging tool as the ground engaging tool moves along the ground to form a map showing hardness of the soil as indicated by a varying value of the force.

This invention is in the field of agricultural soil mapping and in particular mapping soil hardness.

### BACKGROUND

Historically in agriculture, a field had to be treated as a whole when deciding fertilizer and seeding rates, since these rates needed to be set on the seeding implement for the field, and could not be changed as the implement moved across the field. The rates were only changed when moving from one field to another if such a change was warranted.

External guidance systems for agricultural field operations, most commonly using guidance signals from the global positioning system (GPS) but sometimes also guidance signals from more local radio towers or the like, allow an operator to determine the location of an implement in a field. This ability has led to the development of field mapping, where the field is divided into management zones, and seeding implement have been developed with the ability to vary application rates for crop inputs like seed and fertilizer in each zone. The agronomic characteristics of agricultural land can vary quite drastically across a field, and mapping the field into zones that have more consistent characteristics allows for increased efficiency in the use of crop inputs.

Soil testing involves actually attending on a field and probing the soil to extract soil samples, and then analyzing the soil samples to determine levels of nutrients in the soil, soil type, and like physical characteristics. In order to determine zone boundaries, it is desirable too keep the samples from different locations separate, so the soil characteristics at each location can be determined. Thus soil testing is a time consuming and costly process.

For this reason other available information have been used to determine field zone boundaries. Topographical information, available from GPS signals, showing elevation contours of the filed can show whether a location is in a low area, a mid-slope area, or hill top area. It is generally accepted that these three areas have certain characteristics in common, and so have a significant influence on zone boundaries.

Satellite images, such as those showing the varying degrees of “greenness” of a crop growing in the field, are also used to determine zone boundaries. The greenness of the crop is an indication of the relative health of the crop in one part of the filed compared to that in another part of the field, and areas of substantially uniform greenness can be determined to also influence the position of zone boundaries.

Present day harvesting equipment allows continuous yield monitoring as the harvester moves across the field such that the yield of prior crops at any location in the filed can be determined. This yield information is also an indicator of crop health and can be helpful in determining management zones.

The available topographical, greenness, yield, and like information such as soil conductivity is analyzed to generate a zone map for the field. The process is described for example in U.S. Pat. No. 6,745,128 to Hanson. Hanson describes mapping soil conductivity as an indicator of nutrient holding capacity, soil texture, and other characteristics, such as salinity, soil depth, organic carbon content, cation-exchange-capacity, and water holding capacity.

Once the management zones are established, soil sampling on a lesser scale can be used to determine the nutrients available in each zone and the rate of each nutrient that should applied in each zone to optimize the use of inputs. Such zone mapping allows each zone to have a different target yield, for example based on soil characteristics in one zone that may be poorer than in another zone, such that one zone is less responsive to nutrient inputs. Seeding rates can be varied for each zone as well, based on desired plant populations for the zone. Thus a “prescription” of crop inputs for each management zone is determined, and the variable application rate system of the seeding implement is programmed to change the application rates as the implement crosses a zone boundary so as to apply the prescription prescribed for each zone.

Thus many kinds of information about the soil as it varies from one area of a field to the next that can be assembled and made available could be beneficial in more accurately determining management zones.

Canadian Patent Application Number 2,584,736 of the present inventor Beaujot discloses a sensor operative to sense the resistance of soil to penetration by a furrow opener mounted on a trailing arm. Such trailing arm furrow openers utilize a packer wheel at the rear end of the arm as a depth gauge such that the furrow openers attached to the arm are vertically controlled by the packer wheel. Because of the interconnected construction the drag and penetrating forces on the ground engaging furrow opener elements directly affect the resulting vertical packing force on the packing element.

On such a furrow opener assembly the drag forces resulting from pulling the furrow opener through the soil, and the upward forces on the furrow opener resulting from the force required to maintain the furrow opener engaged in the ground combine to exert an upward force on the trailing arm. The rolling resistance force required to roll the packer wheel forward along the ground also exerts an upward force on the arm. These upward forces reduce the amount of the downward bias force that is available to force the packer wheel toward the ground and provide packing force.

Soil conditions can vary considerably from field to field and also within a single field and so the packing force varies considerably with the result that in some areas of the field the furrows are over-packed while in other areas the furrows are not sufficiently packed. The Beaujot apparatus is directed to adjusting the downward bias force on the trailing arm as required to maintain the downward force on the packer wheel in a desired range.

Canadian Patent Number 2,004,787 to Baker et al. discloses a similar sensor for and adjusting mechanism for maintaining a substantially consistent penetration depth of the furrow opener and a substantially constant downward force on the depth gauge wheel.

### SUMMARY OF THE INVENTION

It is an object of the present invention to provide a system and method for providing information beneficial for mapping management zones that overcomes problems in the prior art.

While compaction from wheel tracks or the like will cause soil hardness to vary, in general the texture of soil in a field, or the hardness or softness of the soil is an indicator of the type of soil. The degree of hardness of a soil is essentially sensed by the systems of Beaujot and Baker. The harder the soil the greater the resistance to a furrow opener passing through the soil, and the greater the downward force required to maintain the desired constant force on the packer and gauge wheels. In these systems the hardness is constantly sensed as the furrow opener moves through the soil. In the present invention this changing hardness is measured and plotted with location information from an external guidance system such that a map is saved of soil hardness as it varies across a field.

The hardness of the soil is an indicator of soil type, soil texture, and other characteristics that are beneficial in mapping management zones, and the map can be saved with very little cost and effort by simply recording and storing the information as the seeding implement operates normally. In comparison for example, developing a map of the soil conductivity used by Hanson to generate management zones requires a separate operation of moving a soil conductivity sensor across the field.

In a first embodiment the present invention provides an apparatus for mapping resistance of soil to a ground engaging tool passing through the soil. The apparatus comprises a sensor mechanism operative to measure a resistance force exerted on the ground engaging tool by the soil, and an external guidance system operative to determine a location of the ground engaging tool. A microprocessor is operative to receive information from the sensor and external guidance system and operative to plot the force against the location of the ground engaging tool as the ground engaging tool moves along the ground to form a map showing hardness of the soil as indicated by a varying value of the force.

In a second embodiment the present invention provides an agricultural seeding apparatus for mapping resistance of soil to a furrow opener passing through the soil. The apparatus comprises a frame and a trailing arm pivotally attached at a front end thereof to the frame about a substantially horizontal arm pivot axis oriented substantially perpendicular to an operating travel direction of the frame. A bias element is operative to exert a total bias force on the arm. A furrow opener bracket extends downward from a middle portion of the arm, and a furrow opener is attached to a lower end of the furrow opener bracket. A packer wheel is configured to support a rear portion of the arm and is oriented to roll along a furrow made by the furrow opener. A gauge sensor is operative to determine a downward packing force exerted on the furrow by the packer wheel, and a control mechanism is operative to adjust the total bias force to maintain the packing force within a desired range. A bias element sensor is operative to measure the total bias force, and an external guidance system is operative to determine a location of the frame. A microprocessor is operative to receive information from the bias element sensor and external guidance system and is operative to plot the total bias force against the location of the frame as the frame moves along the ground to form a map showing hardness of the soil as indicated by a varying value of the total bias force.

Thus the present invention provides a furrow opener apparatus that provides a map of the relative hardness of the soil in a field, while also providing a packing force or furrow depth that is maintained within a desired range.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic side view of an embodiment of an agricultural seeding apparatus of the present invention;

FIG. 2 is a schematic side view of an alternate embodiment of the furrow opener apparatus of the present invention;

FIG. 3 is a schematic side view of a further embodiment of the furrow opener apparatus of the present invention;

FIG. 4 is a schematic top view of the attachment of the packer wheel to the trailing arm in the embodiment of FIG. 3;

FIGS. 5 and 6 illustrate examples of maps of soil hardness made by an apparatus of the present invention;

FIG. 7 schematically illustrates an alternate embodiment of an agricultural seeding apparatus of the present invention where the furrow opener is a disc, and where the gauge member is a gauge member beside a rear portion of the disc.

### DETAILED DESCRIPTION OF THE ILLUSTRATED EMBODIMENTS

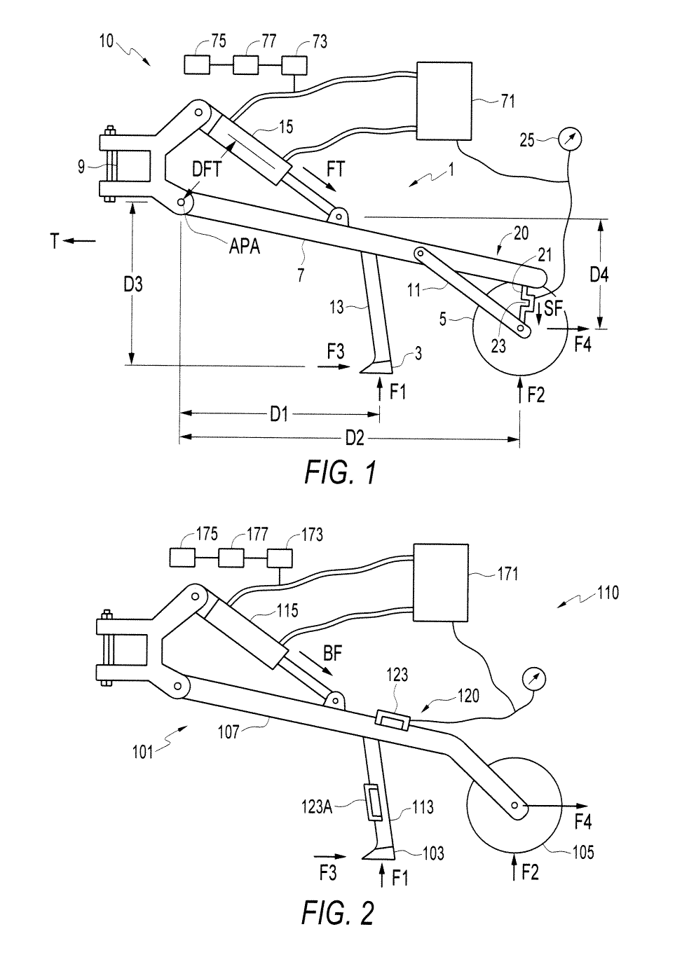

FIG. 1 illustrates a schematic side view of an embodiment of apparatus of the present invention for mapping resistance of soil to a ground engaging tool passing through the soil. The apparatus comprises a sensor mechanism operative to measure a resistance force exerted on the ground engaging tool by the soil, an external guidance system operative to determine a location of the ground engaging tool, and a microprocessor operative to receive information from the sensor and external guidance system and operative to plot the force against the location of the ground engaging tool as the ground engaging tool moves along the ground to form a map showing hardness of the soil as indicated by a varying value of the force.

In the apparatus of the present invention is illustrated as an agricultural seeding apparatus 10 where the ground engaging tool is a furrow opener 3. In the embodiment the apparatus 10 also maintains the packing force exerted by a packer wheel 5 on a furrow in a desired range. The apparatus 10 comprises a frame 9 and a furrow opener assembly 1 mounted to the frame 9.

The furrow opener assembly 1 comprises a furrow opener 3 and a gauge member configured to control a depth of a furrow made by the furrow opener 3. In the illustrated apparatus 10, the gauge member is provided by a packer wheel 5 oriented to roll along a furrow made by the furrow opener 3. The furrow opener assembly 1 comprises a trailing arm 7 attached at a front end thereof to the frame 9 about a substantially horizontal arm pivot axis APA oriented substantially perpendicular to the operating travel direction T of the frame 3. The packer wheel 5 supports a rear portion of the trailing arm 7 and the furrow opener 3 is located forward of the packer wheel 5. Thus the trailing arm 7, and the furrow opener 3 attached thereto, pivot up and down about the arm pivot axis APA as the vertical positions of the frame 9 and packer wheel 5 vary with respect to each other when following undulating terrain. Thus the packer wheel 5 acts as a gauge to control the depth of the furrow, in addition to packing the furrow.

A bias element, illustrated as a hydraulic cylinder 15 connected to an active hydraulic source, is operative to exert a total bias force FT on the furrow opener assembly 1 such that a first downward force F1 is exerted on the furrow opener 3 and a second downward force F2 is exerted on the gauge member. FIG. 1 represents these downward forces by corresponding upward force arrows to more clearly show the sum of the forces making up the total bias force FT. In the apparatus 10 of FIG. 1 the total bias force FT is exerted on the trailing arm 7. The active hydraulic source exerts a controllable pressure in the hydraulic cylinder 15, and the hydraulic cylinder 15 can extend and retract while exerting the total bias force BF, which total bias force BF can be varied by varying the pressure of the fluid in the hydraulic cylinder 15.

A gauge sensor 20 is operative to measure the second downward force F2 which is the downward packing force on the packer wheel 5 exerted on the furrow by the packer wheel 5. In the embodiment of FIG. 1 the gauge sensor 20 comprises a wheel bracket 11 pivotally attached at a front end thereof to a rear portion of the trailing arm 7, with the packer wheel 5 in turn rotatably attached to the rear end of the wheel bracket 11. The gauge sensor 20 also comprises a sensor link 21 connecting the trailing arm 7 and the wheel bracket 11 such that the position of the wheel bracket 11 with respect to the trailing arm 7 is substantially fixed. The packer wheel 5 on the wheel bracket 11 would be free to move up and down with respect to the arm 7, except that the sensor link locks the two together. The sensor link 21 includes a sensor 23 operative to determine the sensed force SF exerted on the wheel bracket 11 by the bias element 13 through the trailing arm 7, from which the packing force F4 can be determined. A measure of the packing force can be indicated to an operator on a display 25.

The hydraulic cylinder 15 thus applies a force FT on to the trailing arm 7. The force FT is set by the operator by adjusting the pressure in hydraulic cylinder 15. The cylinder 15 creates a downward moment around the arm pivot axis APA 9 equal to FT times the perpendicular distance DFT between the cylinder center and pivot axis APA. During operation opposite upward moments are created as result of engaging the furrow opener 3 in the soil. For example the rearward force F3 is a result of the soil resisting travel of the furrow opener 3 through the soil. Upward force F1 is a result of the soil resisting downward penetration of the furrow opener 3 into the soil. Rearward force F4 is a result of rolling resistance of the soil to the rotation of the packer wheel 5. The difference between the upward moments (F1×D1+F3×D3+F4×D4) and the downward moment (FT×DFT) provided by the hydraulic cylinder 15 is what is left to provide the packing force F2, which creates a moment F2×D2.

Since all distances are substantially fixed, and F1, F3, and F4 vary with soil conditions, in order to maintain the second downward force F2 within a desired range to maintain a substantially uniform resultant vertical packing force F2, the pressure in hydraulic cylinder 15 must be varied so that FT compensates for the varying soil forces to provide a packing force F2 that is within the range. As the hardness of the soil increases, the resistance of the soil to the furrow opener 3 passing through the soil increases and the forces F1 and F3 increase, and the total bias force FT increases to compensate and keep the packing force F2 in the desired range. The rolling resistance F4 is a relatively smaller force, and so the total bias force FT at any time is an indicator of the soil resistance forces F1 and F3 at that time. For the purposes of the invention only an indication of the relative hardness and softness of the soil is required, rather than an absolute measured quantity.

Similarly the actual quantified packing force need not be determined as an operator will typically note the sensed force SF and inspect the field behind the implement to judge if packing is satisfactory. The operator will then know which range of values of SF will provide a satisfactory packing force, and can maintain the pressure in the hydraulic cylinder 15 accordingly. A control mechanism 71 is operative to receive information from the gauge sensor 20 and adjust the total bias force FT by adjusting the pressure of the pressurized fluid in the hydraulic cylinder 15 to maintain the second downward force F2, which provides the packing force, within the desired range.

To provide the required mapping function, a bias element sensor 73 is operative to measure the total bias force FT by sensing the pressure in the hydraulic cylinder 15, and an external guidance system 75, such as a receiver for global positioning signals, is operative to determine a location of the frame 9 as it moves through the field. A microprocessor 77 is operative to receive information from the bias element sensor 73 and external guidance system 75 and is operative to plot the total bias force FT against the location of the frame 9 as the frame moves along the ground to form a map showing hardness of the soil as indicated by a varying value of the total bias force FT.

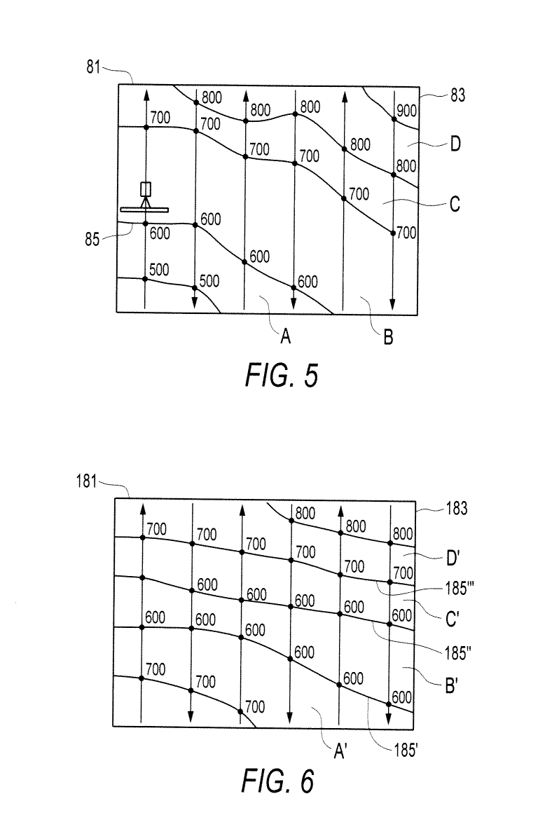

An example of such a map 81 is illustrated in FIG. 5. The field 83 is a rectangular field and the frame 9 is moved back and forth in adjacent passes across the field as indicated by the arrows. The map 81 comprises lines 85 connecting locations where the total bias force FT is substantially the same. The numbers 500, 600, 700, 800 indicate the pressure in the hydraulic cylinder at the marked locations and the lines thus indicate the boundary between different soil hardness zones, using a pressure difference of 100 psi as a more or less arbitrary point to delineate a zone boundary. Depending on the application, a greater or lesser pressure difference may be selected to delineate boundaries.

Zone A is a zone with relatively less soil hardness where the pressure in the hydraulic cylinder 15 is between 500 and 600 psi. Similarly Zone B is a zone with increased soil hardness where the pressure in the hydraulic cylinder 15 is between 600 and 700 psi, Zone C is a zone with further increased soil hardness where the pressure in the hydraulic cylinder 15 is between 700 and 800 psi, and Zone D is a zone with relatively less soil hardness where the pressure in the hydraulic cylinder 15 is between 800 and 900 psi.

In the map 181 of FIG. 6, the field 183 is again rectangular, however the hardness is much more consistent than in the map 81 of FIG. 5. The Zone A′ is a zone with soil hardness indicated by a pressure in the hydraulic cylinder 15 of between 600 and 700 psi. Moving upward and to the right at line 185′ the pressure drops below 600 psi but never reaches the next delineation pressure of 500 psi but instead rises again back to 600 psi at line 185″ and then rises again to 700 psi at line 185′″. Zone B′ between lines 185′ and 185″ is thus a zone with an indicated soil hardness of a pressure in the hydraulic cylinder 15 of between 500 and 600 psi, and zone C′ is a zone with soil hardness indicated by a pressure in the hydraulic cylinder 15 of between 600 and 700 psi.

FIG. 2 illustrates an alternate seeding apparatus 110 and furrow opener assembly 101 where the gauge sensor 120 is provided by a strain gauge type sensor 123 which measures the bending forces on the trailing arm 107 caused by the total bias force FT exerted by the hydraulic cylinder 115 forcing the packer wheel 105 against the ground, and thus allows determination of the packing force F2.

It is contemplated that the gauge sensor could be configured to more indirectly determine the downward packing force F2 exerted on the furrow by the packer wheel 5 by measuring the forces F1 and F3 exerted on the furrow opener 103 by the soil. Thus instead of orienting the gauge sensor to measure the bending forces in the trailing aim 107, the sensor could be configured as illustrated by sensor 123A to measure the bending forces on the furrow opener bracket 113. The forces F1 and F3 on the furrow opener 103 vary with soil conditions, causing the packing force F2 to vary. It is contemplated that by measuring the changing bending forces on the furrow opener bracket 113, and ignoring the rolling resistance F4 which is not expected to vary significantly compared to the variance in the soil forces F1, F3 on the furrow opener 103, an approximation of the packing force can be derived that will be satisfactory for the purposes of the seeding apparatus 110.

Gauge sensor 120 sends information to control mechanism 171 which adjusts the total bias force FT by adjusting the pressure of the pressurized fluid in the hydraulic cylinder 115.

To provide the required mapping function, the bias element sensor 173, external guidance system 175, and microprocessor 177 operate as described above to form a map showing hardness of the soil as indicated by a varying value of the total bias force FT.

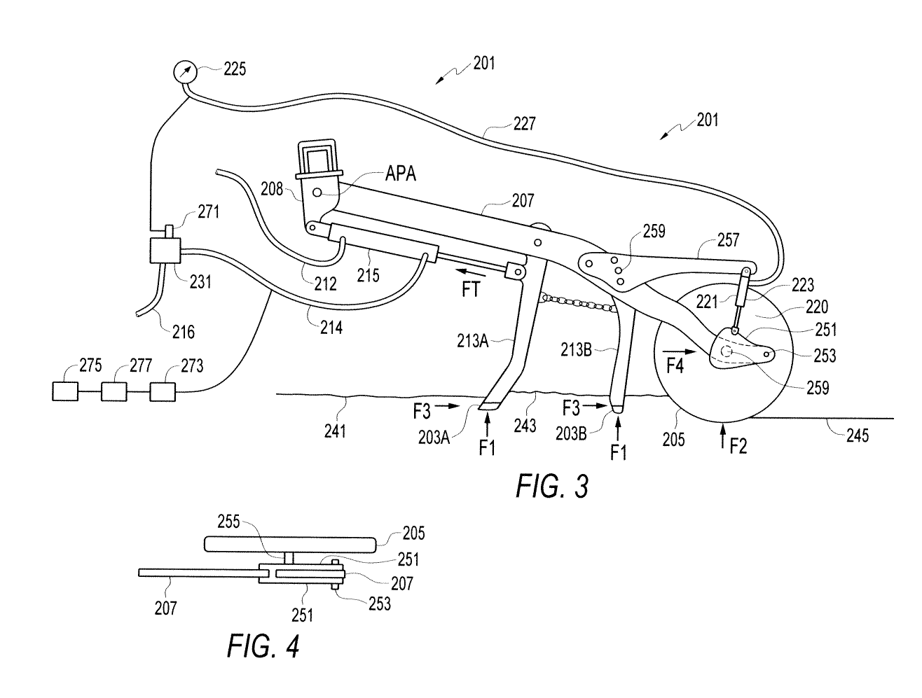

FIG. 3 illustrates a further alternative seeding apparatus 210 and furrow opener assembly 201 with two furrow openers, a front fertilizer furrow opener 203A and a rear seed furrow opener 203B mounted on the bottom of corresponding furrow opener brackets 213A, 213B. There thus are three ground contacting elements the fertilizer furrow opener 203A, the seed furrow opener 203B, and the packer wheel 205. The ground contacting elements are mounted on the rear portion end of the trailing arm 207. The trailing arm 207 is pivotally mounted to a hanging bracket 208 at arm pivot axis APA. The hanging bracket 208 also includes pivot mount for pivotally mounting active hydraulic cylinder 215.

Hydraulic hose 212 is used as an oil return in the field working position and as the oil supply line when lifting the apparatus 201 off the ground. Hydraulic hose 214 supplies the active oil from the pressure-control valve 231 to cylinder 215. Valve 231 is pressure adjusted via control 271. Hydraulic hose 216 supplies pressurized tractor hydraulic oil to valve 231. It is noted that, in contrast to the embodiments of FIGS. 1 and 2, in the embodiment of FIG. 3 the hydraulic cylinder is located under the trailing arm 207 and thus exerts a bias force BF in the retracted direction rather than the extended direction to exert the required downward total bias force FT on the trailing arm 207.

The undisturbed ground surface is indicated at 241, the soil surface loosened by the furrow openers is indicated at 243, and the final packed soil surface is indicated at 245.

The soil exerts drag soil reaction forces F3 and F3′ and vertical soil penetrating reaction forces F1 and F1′ on the furrow openers 203A, 203B, and exerts a rolling resistance soil reaction force F4 on the packer wheel 205. These forces as described above with respect to the embodiment of FIG. 1 combine to create an arm lifting moment around the arm pivot axis APA.

The active hydraulic cylinder 215 applies a total bias force FT on to the trailing arm 207. The force FT is set by the operator by adjusting the pressure in valve 231. The cylinder 215 creates an arm lowering moment around the arm pivot axis APA. F2 is the resultant soil vertical packing force acting on the packer wheel 205. The resulting force is equal to the opener lowering moments minus the opener lifting moments divided by the corresponding distances as described above. Again, since all distances are substantially fixed and F1, F1′, F3, F3′, and F4 vary with soil conditions, in order to maintain a uniform resultant vertical packing force F2, the cylinder pressure must be varied so that FT compensates for the varying soil forces to provide a packing force F2 within the desired range.

To provide the gauge sensor 220 in the embodiment of FIG. 3, the packer wheel 205 is mounted to a wheel plate 251 that is pivotally attached to a rear portion of the trailing arm 207. A top view of the wheel plate 251 is shown in FIG. 4 and shows that there are two wheel plates 251 with the rear end of the trailing arm 207 between them. The plates 251 are attached together and pivot up and down on pivot pin 253 extending through the plates 251 and the rear end of the tailing arm 207. The axle 255 of the packer wheel 205 is attached to the inner one of the wheel plates 251. As illustrated in FIG. 3, a sensor mount 257 is rigidly attached to the trailing arm 207 by bolts or pins through holes 259 which allow for adjustment of the vertical location of the packer wheel 205 with respect to the furrow openers 3A, 3B to adjust the depth of the furrows.

A sensor link 221 connects the sensor mount 257 and the wheel plates 251 such that the position of the wheel plates 251 with respect to the sensor mount 257 is substantially fixed. The sensor link 221 includes a load sensor 223 operative to determine a force exerted on the plate 251 by the sensor mount 257 as a result of the bias force F7 exerted on the trailing arm 207 by the hydraulic cylinder 215.

By allowing plate 251 to pivot freely about pivot pin 253 and mounting the load sensor 223 between plates 251 and sensor mount 257, the load sensor 223 can continually determine the packing force F2. An indication of the sensed force is then sent via cable or hose 227 to a monitor 225 visible to the operator. A change in the sensed force directly adjusts the valve 231 via valve control mechanism 271. The control mechanism 271 can be programmed to calculate an average reading over a short time and adjust pressure based on the average, thereby smoothing and damping the operation of the valve 231.

As illustrated in FIG. 3, the sensor mechanism 220 can be configured such that the pivot pin 253 about which the wheel plates 251 pivot is approximately the same vertical distance off the ground as the rotational axis 259 of the packer wheel 205 so that the sensor 223 does not detect the rolling resistance force FT.

To provide the required mapping function, the bias element sensor 273, external guidance system 275, and microprocessor 277 operate as described above to form a map showing hardness of the soil as indicated by a varying value of the total bias force FT.

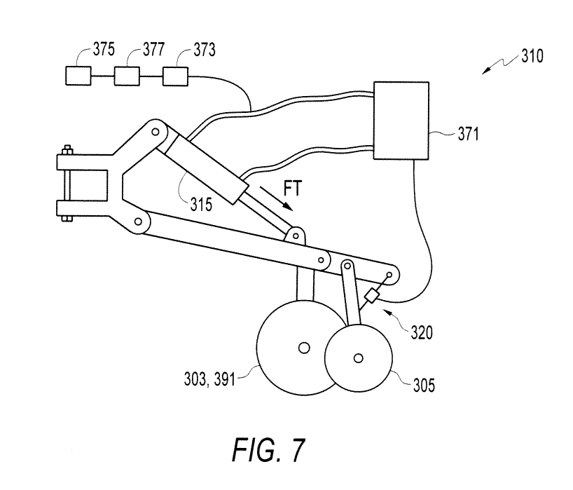

FIG. 7 schematically illustrates an alternate embodiment of the seeding apparatus 310 where the furrow opener 303 comprises a disc 391, and wherein the gauge member comprises a gauge wheel 305 oriented to roll along the soil beside a rear portion of the disc 391 but does not provide direct packing of the furrow as in the embodiments described above. The gauge sensor 320 is configured to measure the down force on the gauge wheel 305, and the control mechanism 371 is operative to vary the pressure in the hydraulic cylinder 315 providing the total bias force FT so as to maintain the down force on the gauge wheel 305 in a desired range, and so to maintain the disc 391 at a desired substantially constant depth to make a furrow of a desired consistent depth.

To provide the required mapping function, the bias element sensor 373, external guidance system 375, and microprocessor 377 operate as described above to form a map showing hardness of the soil as indicated by a varying value of the total bias force FT.

The illustrated embodiments show a bias element provided by a hydraulic cylinder, however it is contemplated that a compression spring could provide the required bias force if the compression of the spring, and thus the bias force exerted thereby, could be adjusted readily.

Thus the present invention provides a furrow opener apparatus that provides a map of the relative hardness of the soil in a field, while also providing a packing force or furrow depth that is maintained within a desired range. It is contemplated that one furrow opener assembly mounted on the implement with the sensors described would adequately indicate the hardness of the soil in the field. Such hardness indicators would be taken at intervals across the filed equal to the width of the seeding apparatus frame, which it is contemplated would be adequate to provide hardness information that would be useful.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. An apparatus for mapping resistance of soil to a ground engaging tool passing through the soil, the apparatus comprising:
a sensor mechanism operative to measure a resistance force exerted on the ground engaging tool by the soil;
an external guidance system operative to determine a location of the ground engaging tool;
a microprocessor operative to receive information from the sensor and external guidance system and operative to plot the force against the location of the ground engaging tool as the ground engaging tool moves along the ground to form a map showing hardness of the soil as indicated by a varying value of the force.

2. The apparatus of claim 1 comprising a bias element operative to exert a bias force on the ground engaging tool, and wherein the sensor mechanism is operative to measure the bias force.

3. The apparatus of claim 2 comprising a furrow opener assembly comprising a furrow opener and a gauge member configured to control a depth of a furrow made by the furrow opener, and wherein:
the ground engaging tool is provided by the furrow opener; and
the bias element is operative to exert a total bias force on the furrow opener assembly such that a first downward force is exerted on the furrow opener and a second downward force is exerted on the gauge member;
the sensor mechanism comprises a gauge sensor operative to measure the second downward force, and a bias element sensor operative to measure the total bias force; and
a control mechanism is operative to adjust the total bias force to maintain the second downward force within a desired range.

4. The apparatus of claim 3 wherein the total bias force is provided by an extendable cylinder operated by pressurized fluid, and wherein the total bias force is adjusted by adjusting a pressure of the pressurized fluid, and wherein the bias element sensor is operative to measure the pressure of the pressurized fluid

5. The apparatus of claim 3 wherein the gauge member comprises a packer wheel oriented to roll along a furrow made by the at least one furrow opener.

6. The apparatus of claim 3 wherein the furrow opener assembly comprises a trailing arm pivotally attached at a front end thereof to the frame about a substantially horizontal arm pivot axis oriented substantially perpendicular to an operating travel direction of the frame, and wherein the gauge member comprises a packer wheel configured to support a rear portion of the trailing arm and the at least one furrow opener is located forward of the packer wheel, and wherein the bias element exerts the total bias force on the trailing arm.

7. The apparatus of claim 3 wherein the furrow opener assembly comprises front and rear furrow openers and wherein the total bias force on the furrow opener assembly exerts the first downward force on the front and rear furrow openers and the second downward force is exerted on the gauge member.

8. The apparatus of claim 3 wherein the at least one furrow opener comprises a disc, and wherein the gauge member comprises a gauge wheel oriented to roll along the soil beside a rear portion of the disc.

9. An agricultural seeding apparatus for mapping resistance of soil to a furrow opener passing through the soil, the apparatus comprising:
a frame and a trailing arm pivotally attached at a front end thereof to the frame about a substantially horizontal arm pivot axis oriented substantially perpendicular to an operating travel direction of the frame;
a bias element operative to exert a total bias force on the arm;
a furrow opener bracket extending downward from a middle portion of the arm, and a furrow opener attached to a lower end of the furrow opener bracket;
a packer wheel configured to support a rear portion of the arm and oriented to roll along a furrow made by the furrow opener;
a gauge sensor operative to determine a downward packing force exerted on the furrow by the packer wheel; and
a control mechanism operative to adjust the total bias force to maintain the packing force within a desired range;
a bias element sensor operative to measure the total bias force;
an external guidance system operative to determine a location of the frame;
a microprocessor operative to receive information from the bias element sensor and external guidance system and operative to plot the total bias force against the location of the frame as the frame moves along the ground to form a map showing hardness of the soil as indicated by a varying value of the total bias force.

10. The apparatus of claim 9 wherein the map comprises lines connecting locations where the total bias force is substantially the same.

11. The apparatus of claim 9 wherein the bias force is provided by an extendable cylinder operated by pressurized fluid, and wherein the bias force is adjusted by adjusting a pressure of the pressurized fluid, and wherein the bias element sensor is operative to measure the pressure of the pressurized fluid.

12. The apparatus of claim 9 wherein the gauge sensor comprises:
a wheel bracket pivotally attached to a rear portion of the trailing arm, wherein the packer wheel is rotatably attached to the wheel bracket;
a sensor link connecting the trailing arm and the wheel bracket such that the position of the wheel bracket with respect to the trailing arm is substantially fixed, the sensor link comprising a sensor operative to determine a force exerted on the wheel bracket by the sensor mount.

13. The apparatus of claim 9 wherein the gauge sensor comprises a sensor operative to determine bending forces on the arm.

14. The apparatus of claim 9 wherein the gauge sensor comprises:
a wheel plate pivotally attached to a rear portion of the trailing arm, wherein the packer wheel is rotatably attached to the wheel plate;
a sensor mount rigidly attached to the arm;
a sensor link connecting the sensor mount and the wheel plate such that the position of the wheel plate with respect to the sensor mount is substantially fixed, the sensor link comprising a sensor operative to determine a force exerted on the plate by the sensor mount.

15. The apparatus of claim 14 wherein the wheel plate is pivotally attached to the trailing arm at a plate pivot axis and wherein the plate pivot axis and a rotational axis of the packer wheel are substantially the same distance above ground level.
